(19) United States
(12) Patent Application Publication
(10) Pub. No.: US 2008/0206721 A1
(43) Pub. Date: Aug. 28, 2008

(54) Method and Device for a Game and for Drawing with Magnets

(76) Inventors: Eyal Haik, Beer Sheva (IL); Yair Menashe, KibbutzBet Kamma (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 12/033,026

(22) Filed: Feb. 19, 2008

Related U.S. Application Data
(60) Provisional application No. 60/902,743, filed on Feb. 23, 2007.

(51) Int. Cl. G09B 11/00

(52) U.S. Cl. 434/88

(57) ABSTRACT

Drawing instrument divided into two parts and held together with magnets and a partition between the two parts. One side of the partition is the surface that is drawn upon. Movement of the hand held part will cause a corresponding movement of the tracing part, thereby tracing the drawing on the surface that is drawn upon.

Owing to the change in polarity on the edge of a cylindrical or cuboid shaped magnet, the drawing portion of the instrument can be made to lie parallel with the page being drawn upon and thereby be moved around the page without marking the page.

### FIELD of the INVENTION

This invention is a game using magnets to draw pictures.

### BACKGROUND of the INVENTION

For a game to be successful, it should be innovative, somewhat of a challenge to the players in the intended age range, and create a sense of satisfaction when finished.

Other ingredients could be an element of surprise, excitement, competition to win, or combination of skill and luck. The above is not an exhaustive list.

Not all games have all the above-mentioned characteristics but some of the characteristics should be present in order to attract players and make a successful game.

Magnets often attract and/or excite people, especially children, because of the invisible forces surrounding them, causing other magnets or unmagnetized metal to move in sometimes-unpredictable ways. Magnets are particularly suitable for children's games as they are non-toxic and environmentally friendly. They keep their almost-magical power for years without needing batteries or other means of renewal of power. They are relatively inexpensive to purchase and have no ongoing maintenance costs.

This invention uses magnets for the above reasons and other reasons like, their suitability to carrying out the functions involved in this invention.

### SUMMARY of the INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention involves one person operating the moving parts of the game, usually tracing a tracing tool, with a magnet at the tracing end, over the lines of a picture on a paper held close to one side of a thin board or partition. On the other side of the board could be a sketching tool held against the said board by a magnet of opposite polarity from that of the said tracing tool. On the side of the board of the said sketching tool, there could be a blank piece of paper adjacent to the board and there could be any number of people, to be the spectators of the entertainment or to be actively involved in, for example, guessing what picture will emerge, as the tracer progresses with the picture.

Another option for a game would be for there to be a blank page on the side of the tracing tool and the tracer traces the shape of, for example, letters, numbers or pictures, in horizontally inverted form (known commonly as mirror image). After all participants have tried their hand at the same image, comparisons are made to determine the best result. Needless to say, as each participant is taking his turn, the others who are watching the results on the other side of the said board could hint how well or otherwise he is progressing.

Yet another game option could be for the page on the side of the tracing tool to have a picture but there would not be a pen or marker in the tracing tool. The spectators would just see the said tool moving (from the magnetic forces) over the said page. They would try to guess the picture or shape that is on the side of the tracer.

### BRIEF DESCRIPTION of the DRAWINGS

The accompanying drawings, which are incorporated in and form a part of this specification, illustrate embodiments of the invention and, together with the description, serve to explain, by way of example only, the principles of the invention:

FIG. 1 is a schematic depiction of the invention showing its essential component parts.

FIG. 2 is a schematic depiction of the tracing tool.

FIG. 3 is a schematic depiction of the sketching tool.

FIG. 4 is a schematic depiction of a sketching tool housing.

FIG. 5 is a schematic depiction of the writing implement in the sketching tool housing.

FIG. 6 is a schematic depiction of the invention showing one technique used when drawing a picture.

FIG. 7 is a schematic depiction of the sketching tool in action.

FIG. 8 is a schematic depiction in perspective of the tracing tool about to move the sketching tool to a different part of the picture.

FIG. 9 is a schematic depiction in perspective of the sketching tool about to be moved to a different part of the picture, by the magnetic pull of the tracing tool.

### DESCRIPTION of the PREFERRED EMBODIMENTS

As will be appreciated the present invention is capable of other and different embodiments than those discussed above and described in more detail below, and its several details are capable of modifications in various aspects, all without departing from the spirit of the invention.

Accordingly, the drawings and description of the embodiments set forth below are to be regarded as illustrative in nature and not restrictive.

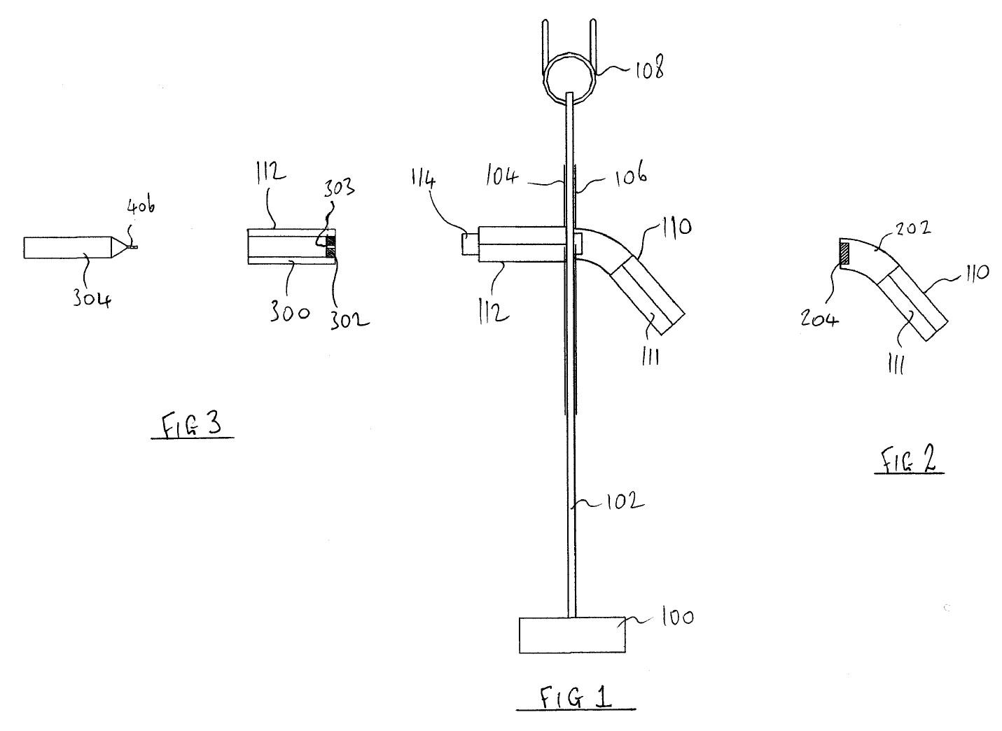

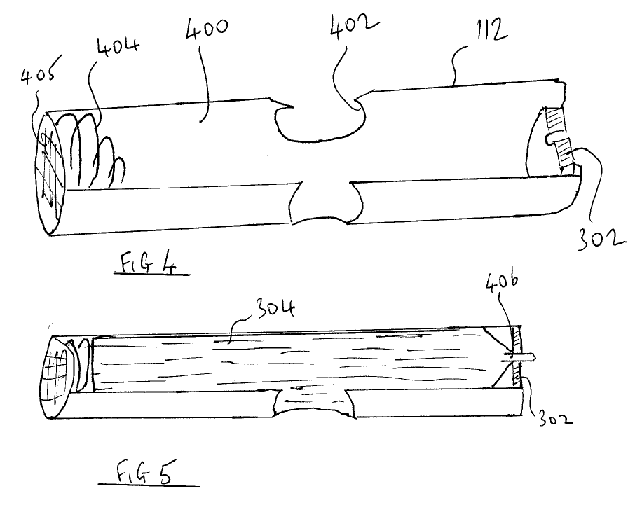

FIG. 1 shows the invention from the side view where the weighted base 100 holds a board 102 in the upright position. The board 102 is preferably made of a relatively thin, firm, smooth but non-metallic material. A blank sheet of paper 104 is held flat against the board 102 and the sheet of paper 106 with a picture on it is held flat against the other side of the board 102. The two sheets of paper 104 and 106 are held in place by, for example, a spring clip 108. The tracing tool 110 is shown positioned in place ready to trace. It has a handle 111 for gripping and the other end is held against the paper 106. It is further described in FIG. 2 below.

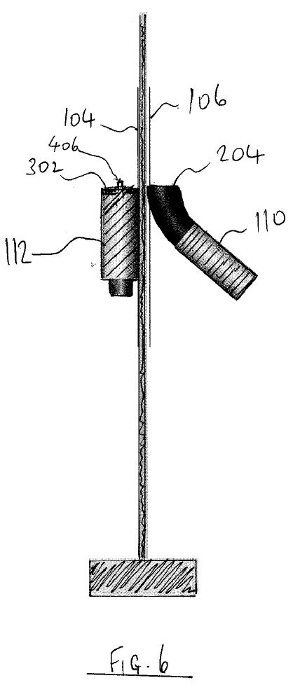

The sketching tool 112 has one end against the blank paper 104 and is positioned opposite the tracing tool 110, being held in place by its magnetism and the opposite pole magnetism of the magnet attached to the tracing tool 110. The sketching tool could be a hollowed out rubber or plastic material able firmly to hold against the paper 104, the writing implement FIG. 3 304 whose rear-end can be seen in FIG. 1 114. In one embodiment, there could be a hollowed out rubber or plastic material open approximately half way along its length, as can be seen in FIG. 4, which would hold the writing implement FIG. 5 304 against the paper 104 by means of the spring FIG. 4 404. The sketching tool 112 is further described in FIGS. 3, 4 and 5 below.

In all embodiments of the invention, the magnetic pole of the side of the magnet in the tracing tool 110 facing the paper 106 is opposite to the magnetic pole of the side of the magnet in the sketching tool 112 facing the paper 104. This fact of opposite magnetic poles enables the movement of the tracing tool 110 correspondingly to move the sketching tool 112. As the sketching tool 112 contains a writing implement FIG. 3 304 whose point or writing end FIG. 3 406 touches the paper 104, every movement of the tracing tool 110 will cause the corresponding movement of the writing implement on the paper, thereby creating a picture. Paper 104 could be any material for writing and/or drawing on, for example a “white board” and the sketching tool FIG. 3 304 would be changed accordingly.

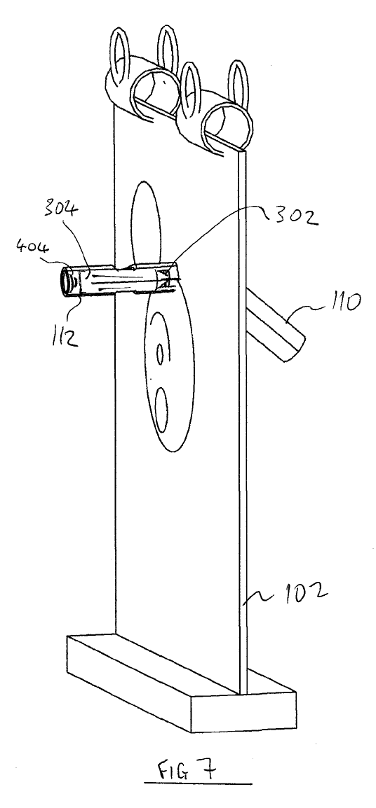

FIG. 2 shows the tracing tool 110. It can be seen that its shape is angled 202. This is to ease a particular movement of the tracing tool 110 used with this invention. This aspect of this invention is described in more detail in the description of FIGS. 6, 8 and 9. The tracing tool 110 has a handle 111 for gripping by a person's hand. Using this handle 111 the operator of this invention moves the tracing tool freely or along lines of a picture on the paper FIG. 1 106. The magnet 204 is situated at the extremity of the tracing tool 110. The purpose of the magnet 204 is to attract the magnet of the sketching tool FIG. 1 112 to itself so that the two tools move together. The corresponding image will be drawn by the sketching implement FIG. 3 304 on the paper FIG. 1 104. That image will be horizontally inverted (mirror image) compared with the picture traced by the tracing tool.

FIG. 3 shows the sketching tool 112. The outer sleeve 300 can be made of rubber, elastic, plastic or other suitable material that would grip the sketching implement 304 sufficiently firmly that the sketching implement 304 would keep its writing or coloring end 406 touching the paper FIG. 1 104.

At the end of the sleeve 300, facing the paper FIG. 1 104, is a magnet 302. This magnet 302 has a hole 303 bored through the center of the magnet 302 to enable the writing point 406 of the sketching implement 304 to reach the paper FIG. 1 104.

The magnet 302 would have its polarity facing the opposite of the polarity of the magnet 204 in FIG. 2, so that the two said magnets would be attracted to each other when they are close to each other. Therefore the movement of the tracing tool FIG. 1 110 would cause the equivalent movement of the sketching tool 112 thereby creating shapes or a picture on the paper FIG. 1 104.

FIG. 4 shows an alternative method of holding the sketching tool 112. It comprises a partially open cylinder 400 with bored magnet 302 at one extremity. Instead of having an open end as shown in FIG. 3, there could be a spring 404 at one extremity attached to its closed end 405. The spring 404 would ensure that the sketching implement FIG. 5 304 is pushed forward and held at close to constant pressure against the paper FIG. 1 104. The partially open cylinder would facilitate the installation of the sketching implement FIG. 5 304, especially if there were finger gaps 402.

FIG. 5 shows the sketching implement 304 in place with its writing point 406 protruding slightly beyond the bored magnet 302.

FIG. 6 shows the present invention when it is desired to move the sketching tool 112 to a different position on the paper 104 without marking the paper 104. This is a common need as can be seen in FIG. 7, where the person drawing, finishes a part of the picture and desires to move the sketching tool 112 to another part of the same picture. He will not want to mark the paper until he reaches the point where he wishes to start the next part of the drawing. To achieve this movement without sketching, using this invention, the drawer twists around the tracing tool 110, thereby taking the flat surface of magnet 204 off the paper 106. When doing this twisting around, the person drawing does not remove the magnet 204 from the paper 106 but keeps the magnet-end of the tracing tool 110 close to the paper 106. This action of twisting the tracing tool 110 has the effect on the magnet 302 of the sketching tool 112 to repel the face of the magnet 302 which was facing the paper 104 when drawing the picture. The sketching tool 112 does not fall but is moved from being perpendicular to being parallel to the paper 104. The edge of magnet 302 is attracted to the opposite pole of the edge of magnet 204 of the tracing tool 110. This enables the tracing tool 110 to drag the sketching tool 112 to whichever position is desired on the paper 104 in order to start the next portion of the picture, without marking the paper 104 while dragging the sketching tool. This is the situation depicted in FIG. 6. As soon as the person operating the tracing tool 110 has reached a point where he wishes to resume drawing, he turns the tracing tool 110 so that the exposed face of magnet 204 faces the paper 106. This has the effect of attracting the exposed face of magnet 302, pulling magnet 302 towards paper 104 and thereby bringing the point 406 of the sketching tool 112 in contact with the paper 104.

FIG. 7 shows the tracing tool 110 in its position for tracing. The sketching tool 112 is in its position for sketching. Also shown are some of the component parts of the sketching tool namely, the sketching implement 304, the spring 404 and the magnet 302.

As the tracing tool 110 moves on the other side of board 102, the sketching tool 112 will trace a picture accordingly.

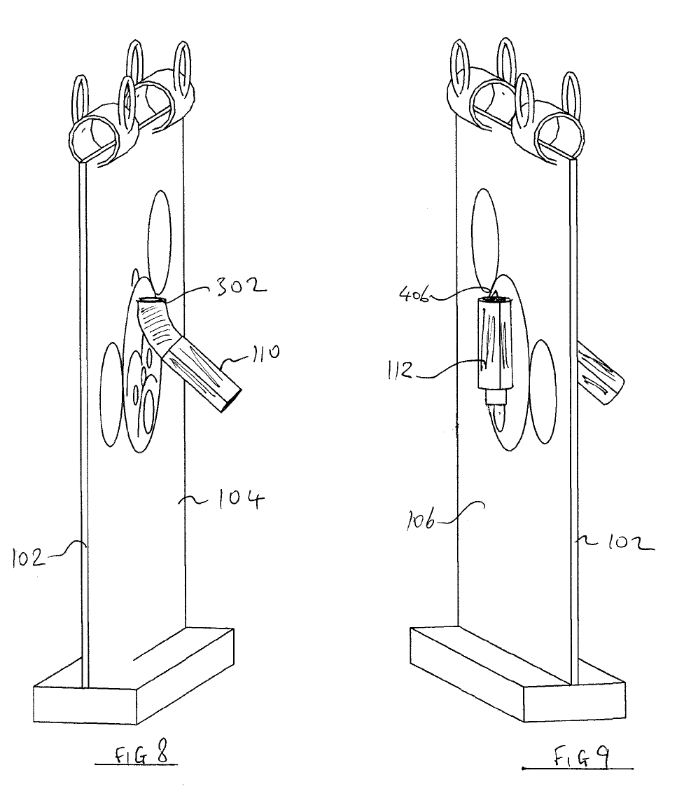

FIGS. 8 and 9 show in perspective form, the board 102 where the tracing tool 110 is turned so that the magnet 302 is facing is away from the paper 104 and the edge of the magnet 302 then touches the paper 104. This is done in order to flip the writing point 406 in the sketching tool 112 off the paper 106 and drag the sketching tool 112 to a different part of the drawing without marking the paper.

What is claimed is:

The present invention is not intended to be limited to the embodiments described above, but to encompass any and all embodiments within the scope of the following claims:

1. A game for drawing comprising,
a. a tracing tool with a magnet at one extremity having one polarity facing away from the said tracing tool, and
b. a sketching tool with a sketching implement attached to the said sketching tool and a magnet at one extremity having the opposite polarity facing away from the said sketching tool, whereby the said tracing tool touching one side of a partition controls, by means of the magnetic attraction force, the movements of the said sketching tool for the purpose of drawing on a surface.

2. A game as claimed in claim 1 wherein the said tracing tool comprises a handle for holding and moving the said tracing tool.

3. A game as claimed in claim 2 wherein the said handle is wholly or partly curved.

4. A game as claimed in claim 1 wherein the said sketching tool comprises a sleeve for gripping the said sketching implement.

5. A game as claimed in claim 4 wherein the said sleeve is partially open along its length in order to aid entry and exit of the said sketching implement.

6. A game as claimed in claim 5 wherein the said sleeve has a spring at the opposite end from the said magnet for the purpose of pushing forward the point of the said sketching implement.

7. A game as claimed in claim 1 wherein the said magnet in the sketching tool has a hole at or near the said magnet's center to enable the writing point of the said sketching implement to pass through the said hole and touch the surface to be drawn upon.

8. A game as claimed in claim 1 wherein a board separates the said two magnets.

9. A game as claimed in claim 1 wherein the said surface for drawing is a sheet of paper.

10. A game as claimed in claim 1 wherein the said surface for drawing is any surface on upon which is suitable for writing.

11. A method for a game for drawing comprising the following steps,
a. placing a tracing tool magnet-end extremity against a partition,
b. placing a sketching tool opposite poled magnet-end extremity and containing a sketching implement against the reverse side of the said partition,
c. moving the said tracing tool to cause the said sketching tool to move in a corresponding manner, thereby forming a sketch on the surface touched by the said sketching implement.

12. A method for a game for drawing as claimed in claim 11 comprising the further steps namely,
a. twisting round the said tracing tool to bring the edge of the said magnet adjacent with the said partition, thereby causing the said sketching implement to lie parallel to the surface being drawn upon,
b. moving the said tracing tool to another position on the reverse side of the said surface while keeping the magnet of the said tracing tool adjacent to the said reverse side, thereby moving the said sketching implement to a corresponding position on the sketching side of the partition, and
c. returning the said sketching tool magnet exposed surface to face the said partition thereby causing the said sketching tool to return to a sketching position.
